(19) United States
(12) Patent Application Publication
(10) Pub. No.: US 2013/0232188 A1
(43) Pub. Date: Sep. 5, 2013

(54) INFORMATION PROCESSING APPARATUS AND CLIENT MANAGEMENT METHOD

(71) Applicants: Takumi Yamashita, Hamura-shi (JP); Tatsuhiko Nomoto, Ageo-shi (JP)

(72) Inventors: Takumi Yamashita, Hamura-shi (JP); Tatsuhiko Nomoto, Ageo-shi (JP)

(21) Appl. No.: 13/609,765

(22) Filed: Sep. 11, 2012

(30) Foreign Application Priority Data
Mar. 5, 2012 (JP) 2012-048572

(51) Int. Cl. G06F 15/16

(52) U.S. Cl. 709/203

(57) ABSTRACT

According to one embodiment, an information processing apparatus manages client terminals belonging to groups organized hierarchically. The information processing apparatus includes an image file generator, a permitted group setting module and a delivery controller. The image file generator generates a disk image file for a first group of the groups, the disk image file including a first OS and a first application program. The permitted group setting module sets a second group of the groups to be a permitted group to which delivery of the disk image file is permitted, wherein the second group is subordinate to the first group. The delivery controller delivers the disk image file to a client terminal belonging to the first group and a client terminal belonging to the permitted group.

### CROSS-REFERENCE TO RELATED APPLICATIONS

This application is based upon and claims the benefit of priority from Japanese Patent Application No. 2012-048572, filed Mar. 5, 2012, the entire contents of which are incorporated herein by reference.

### FIELD

Embodiments described herein relate generally to an information processing apparatus which manages client terminals, and a client management method applied to the apparatus.

### BACKGROUND

In recent years, in various kinds of companies, a system (client management system) for managing, by a server, many client terminals (client computers) in offices has been introduced.

In the client management system, the desktop environments (operating systems, applications) of many client terminals can be centrally managed by a server in the client management system. By the central management, many client terminals can efficiently be managed.

In the client management system, in some cases, such a method is adopted that all client terminals are not respectively managed, but the client terminals are divided into some groups and the client terminals are managed in units of a group. In this method, for example, different operations can be performed in the individual groups, and administrators can be assigned to the individual groups.

There is a case in which groups for managing client terminals are organized according to a hierarchy, like departments in a company. The groups have relationships form a branching, treelike structure. In this case, the server can manage the client terminals, taking into account the superior/subordinate relationship between groups by the hierarchical organization. For example, a rule that a certain file is delivered to a “parent” group may be applied to a “child” group thereof, and this file can also be delivered to the “child” group.

However, when two “child” groups are subordinate to the “parent” group, it may possibly troublesome for the administrator to apply the rule, which is set for the “parent” group, to one “child” group, and to apply another rule to the other “child” group, instead of applying the rule for the “parent” group to the other “child” group.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary conceptual view illustrating a client management system including an information processing apparatus according to an embodiment.

FIG. 2 is an exemplary conceptual view for explaining groups for managing client terminals by the information processing apparatus (management server) of the embodiment.

FIG. 3 is an exemplary conceptual view, for explaining examples of disk image files delivered to the groups shown in FIG. 2.

FIG. 4 is an exemplary block diagram illustrating an example of the configuration of the client management system of FIG. 1.

FIG. 5 is an exemplary block diagram illustrating an example of the functional configuration of the client terminal and the information processing apparatus of the embodiment.

FIG. 6 is an exemplary view illustrating a configuration example of group information which is used by the information processing apparatus of the embodiment.

FIG. 7 is an exemplary view illustrating a configuration example of disk image information which is used by the information processing apparatus of the embodiment.

FIG. 8 is an exemplary view for describing an example in which an entry of disk image information is added by the information processing apparatus of the embodiment.

FIG. 9 is an exemplary view illustrating an example of a permitted group select screen displayed by the information processing apparatus of the embodiment.

FIG. 10 is an exemplary view illustrating another example of the permitted group select screen which is displayed by the information processing apparatus of the embodiment.

FIG. 11 is an exemplary view illustrating another configuration example of the disk image information which is used by the information processing apparatus of the embodiment.

FIG. 12 is an exemplary view illustrating an example of a delivery disk image select screen which is displayed by the information processing apparatus of the embodiment.

FIG. 13 is an exemplary flowchart illustrating an example of the procedure of a delivery image generation process executed by the information processing apparatus of the embodiment.

FIG. 14 is an exemplary flowchart illustrating an example of the procedure of a delivery control process executed by the information processing apparatus of the embodiment.

FIG. 15 is an exemplary flowchart illustrating an example of the procedure of a reception control process executed by the client terminal shown in FIG. 5.

### DETAILED DESCRIPTION

Various embodiments will be described hereinafter with reference to the accompanying drawings.

In general, according to one embodiment, an information processing apparatus is configured to manage a plurality of client terminals belonging to groups organized hierarchically. The information processing apparatus includes an image file generator, a permitted group setting module, and a delivery controller. The image file generator is configured to generate a first disk image file for a first group of the groups, the first disk image file including a first operating system and a first application program. The permitted group setting module is configured to set a second group of the groups to be a permitted group to which delivery of the first disk image file is permitted, wherein the second group is subordinate to the first group. The delivery controller is configured to deliver the first disk image file to a client terminal belonging to the first group and a client terminal belonging to the permitted group.

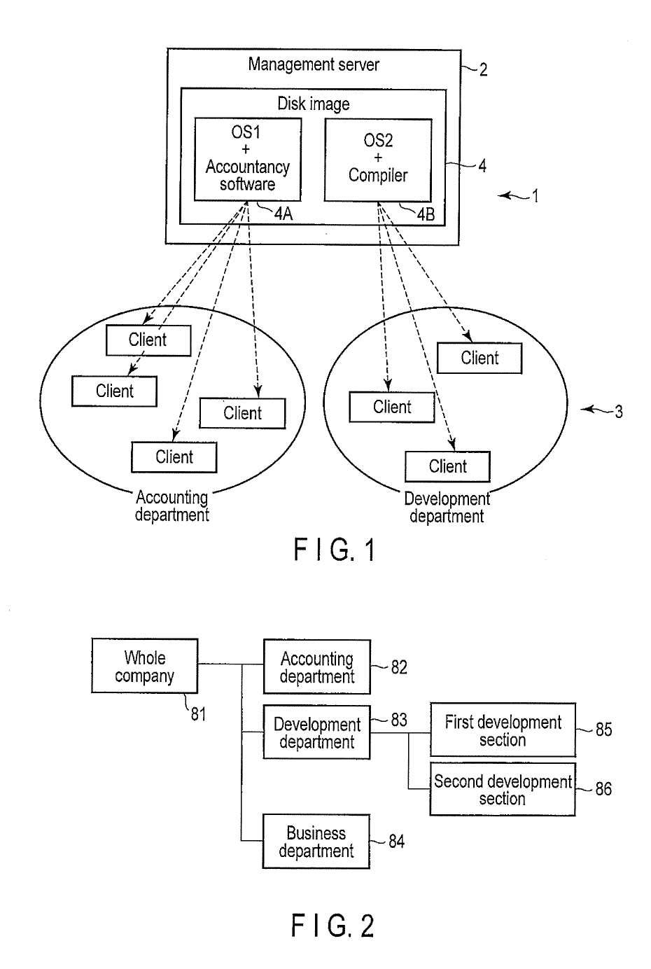

To begin with, referring to FIG. 1, a description is given of an example of a client management system 1 including an information processing apparatus according to an embodiment.

The client management system 1 is a client/server system in which a management server 2 and one or more client terminals 3 are interconnected via a network. The management server 2 may be realized, for example, as a server computer. The client terminal 3 may be realized, for example, as a personal computer (PC).

The management server 2 manages the client terminal 3. The management server 2 delivers to the client terminal 3 a disk image file 4 (hereinafter also referred to as “disk image”) in which, for example, an operating system (OS) and an application program (e.g. accountancy software or a compiler) are installed, thereby managing software, such as an OS or application program, which is installed in the client terminal 3. The disk image file 4 is, for instance, a virtual image file in a virtual hard disk (VHD) format. An arbitrary combination of an OS and an application program is installed in the disk image file 4. The management server 2 can also manage a file for updating an application program which has already been installed in the client terminal 3, a security patch (a module for correcting weakness on security), a pattern file of antivirus software, etc.

The client terminal 3 is a so-called virtualization client terminal. A virtual machine monitor (hypervisor) is installed as virtualization software in a local storage of the client terminal 3. The client terminal 3 executes the virtualization software, and the OS and application program in the disk image file 4 which is delivered from the management server 2.

As shown in FIG. 1, there is a case in which the client terminals 3 are managed in units of a group such as a department (e.g. an accounting department, a development department, etc.) in a company. It is assumed that an OS and an application, which are used, are common in the client terminals 3 in the same group. Thus, the management server 2 delivers the same disk image 4 to the client terminals 3 belonging to the same group. For example, the management server 2 delivers a disk image 4A, in which a first OS and accountancy software are installed, to the client terminals 3 belonging to the “accounting department”, and delivers a disk image 4B, in which a second OS and a compiler are installed, to the client terminals 3 belonging to the “development department”. Thereby, the management server 2 can efficiently manage the client terminals 3 in units of a group.

In addition, the management server 2 manages a plurality of client terminals belonging to a plurality of groups which are hierarchically organized.

FIG. 2 shows examples of groups which are hierarchically organized, as in the case of a hierarchical structure of departments in a company. The hierarchical groups (hereinafter also referred to as “group tree”) have relationships form a branching, treelike structure. In the hierarchical groups, a “child” group may be set for a “parent” group which is an upper-layer group. In the example shown in FIG. 2, with a “whole company” group 81 being set as a “parent”, three “child” groups, namely an “accounting department” group 82, a “development department” group 83 and a “business department” group 84, are set. In addition, with the “development department” group 83 being set as a “parent”, two “child” groups, namely a “first development section” group 85 and a “second development section” group 86, are set.

In the management server 2, for example, various settings relating to groups are executed by administrators of the respective groups. The administrator is a user who is given an administrative privilege, among the users of the client terminals 3 belonging to the group. In the groups having a hierarchical structure, the administrator of a “parent” group can also manage a lower-layer group which is subordinate to this group (i.e. a “child” group or a “grandchild” group). In the example shown in FIG. 2, the administrator of the “development department” group 83 has the right to manage the “development department” group 83 and the subordinate “first development section” group 85 and “second development section” group 86.

In addition, in the case of managing the client terminals 3 in the groups having the hierarchical structure, it is possible to select whether or not to apply a rule, which is set for the “parent” group, to all “child” groups. For example, it is assumed that there is a rule that a first disk image is delivered to the “development department” group 83. In this case, it is possible to select whether or not to deliver the first disk image to the “first development section” group 85 and “second development section” group 86, which are “child” groups of the “development department” group 83.

However, in this rule, it is difficult to specify that the first disk image is delivered to the “development department” group 83 and “second development section” group 86 and a second disk image is delivered to the “first development section” group 85, in order to use a development environment, in which a certain OS and software operate, in the “development department” group 83 and “second development section” group 86, and to use a development environment, in which a different OS and software operate, in the “first development section” group 85. In order to realize the above-described development environment, it is necessary to specify, for example, that the rule for the “development department” group 83 is not applied to the “child” groups, a third disk image having the same content as the first disk image is generated, the third disk image is delivered to the “second development section” group 86, and the second disk image is delivered to the “first development section” group 85. In this method, since the “development department” group 83 and the “second development section” group 86, which use the disk images of the same content, are separately managed, the number of disk images increases, thereby leading to an increase in management cost.

Taking this into account, in the management server 2 of the present embodiment, groups, to which the delivery of the disk image 4 is permitted, is set in association with the disk image 4, so that the delivery image 4 can flexibly be allocated to groups having a hierarchical structure. Thereby, in the above-described example, there is no need to apply individual rules to the “development department” group 83 and the “second development section” group 86, and therefore, the possibility of occurrence of a human error relating to management can be decreased and an increase in management cost can be suppressed.

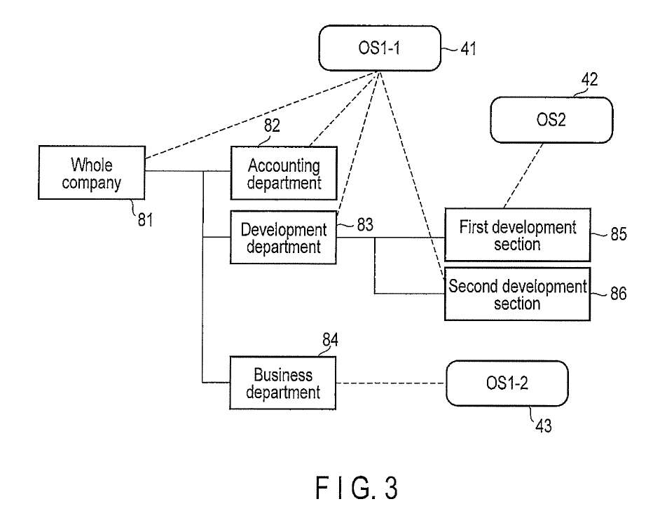

FIG. 3 illustrates an example in which groups, to which the delivery of disk images is permitted, are set among the groups having the hierarchical structure. In the example illustrated in FIG. 3, a first disk image “OS1-1” 41 is delivered to the “whole company” group 81, “accounting department” group 82, “development department” group 83 and “second development section” group 86, a second disk image “OS2” 42 is delivered to the “first development section” group 85, and a third disk image “OS1-2” 43 is delivered to the “business department” group 84.

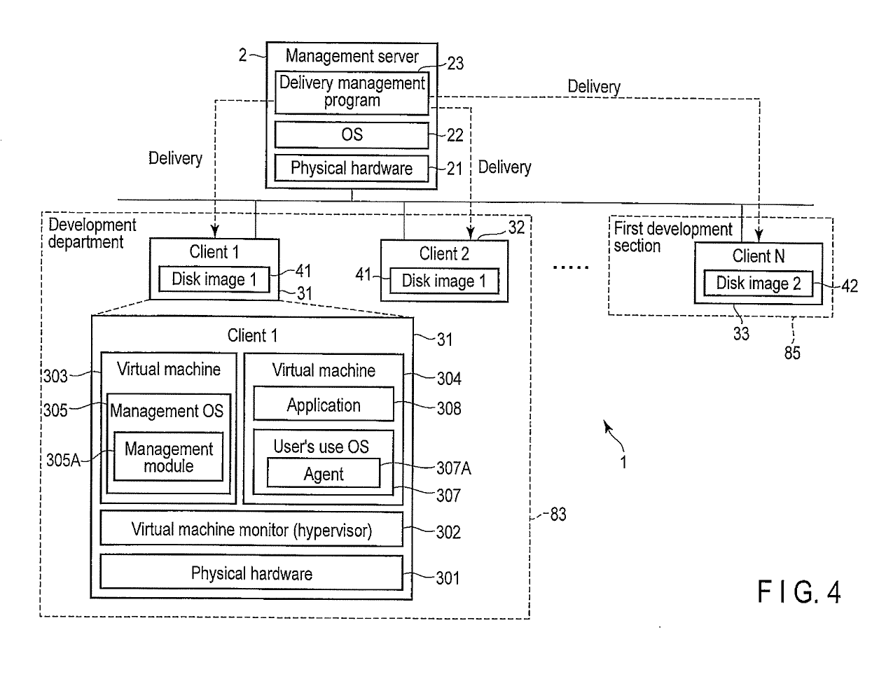

FIG. 4 illustrates an example of the configuration of the client management system 1 for realizing the above-described delivery. In the client management system 1, as described above, the management server 2 and client terminals 31, 32 and 33 are interconnected via a network 1A such as a LAN.

In the management server 2, an OS 22 and a delivery management program 23 are executed by using physical hardware 21 such as a CPU, a memory, a storage and various I/O devices. The delivery management program 23 includes a function of managing delivery of the disk image 4. Specifically, the delivery management program 23 generates the disk image 4, sets the client terminal 3 to which the disk image 4 is to be delivered, and controls the delivery of the disk image 4.

In the client terminal 31, a virtual machine monitor 302 is executed on physical hardware 301 such as a CPU, a memory, a storage and various I/O devices. The virtual machine monitor 302 is virtualization software such as a hypervisor, and functions as a virtualization layer on the physical hardware 301 by emulating resources of the physical hardware 301. Some virtual machines are executed on the virtual machine monitor 302 that is the virtualization layer. In FIG. 4, the case is assumed that two virtual machines 303 and 304 are executed on the virtual machine monitor 302. The virtual machine 303 is a virtual machine for executing a management OS (host OS) 305. On the other hand, the virtual machine 304 executes a user's use OS (guest OS) 307 and an application program 308 in a disk image file 41 which is delivered from the system 1. The virtual machine 304, namely the user's use OS 307 and the application program 308, operates as a desktop environment of the client terminal 31.

The management OS (host OS) 305, in cooperation with the virtual machine monitor 302, can control the virtual machine 304. The management OS 305 includes a management module 305A. The management module 305A can download the disk image file 4 from the management server 2. The user's use OS (guest OS) 307 includes an agent 307A. The agent 307A is a program which executes a process of enabling cooperation between the management server 2 and the client terminal 31. In the meantime, the client terminals 32 and 33 have the same system configuration as the client terminal 31.

The delivery management program 23 delivers, in units of a group to which the client terminal 3 belongs, the disk image file 4 which is associated with this group. For example, in FIG. 4, it is assumed that the client terminals 31 and 32 belong to the “development department” group 83, and the client terminal 33 belongs to the “first development section” group 85. Accordingly, the delivery management program 23 delivers to the client terminals 31 and 32 the first disk image 41 which is associated with the “development department” group 83, and delivers to the client terminal 33 the second disk image 42 which is associated with the “first development section” group 85.

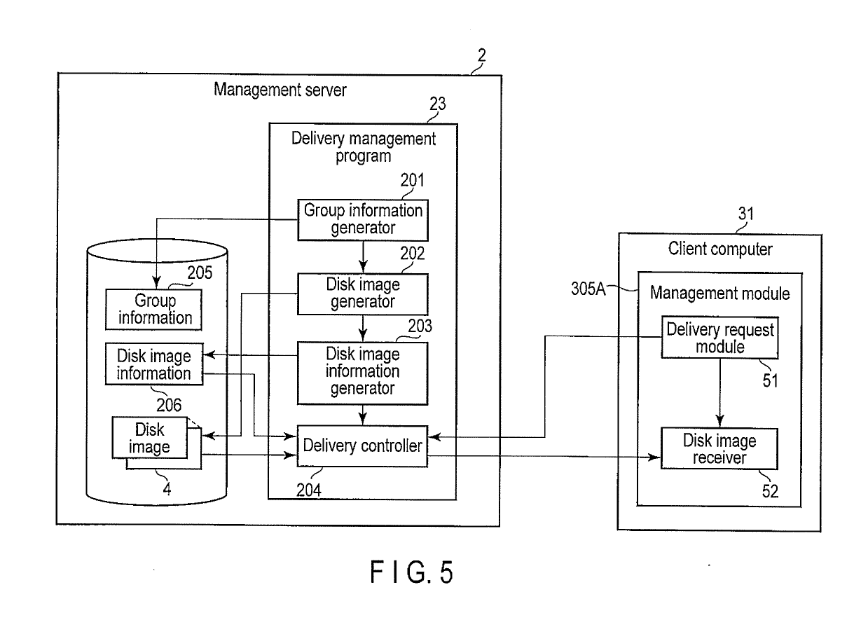

Next, referring to FIG. 5, a description is given of the functional configuration of the management server 2 and the client terminal (client computer) 31.

The delivery management program 23, which is executed on the management server 2, includes a group information generator 201, a disk image generator 202, a disk image information generator 203, and a delivery controller 204.

The group information generator 201 generates group information 205 which defines a hierarchized group to which the client terminal 3 belongs. The group information 205 is generated, for example, in response to a request (operation) by a user (i.e. an administrator) having an administrative privilege. The group information generator 201 determines whether a user who accesses the management server 2 has the administrative privilege. The group information generator 201 permits access to the management server 2 by a user having the administrative privilege, and prohibits access to the management server 2 by a user having no administrative privilege. For example, when the administrator inputs the information indicative of the group name or the superior/subordinate relationship of the group, the group information generator 201 adds to the group information 205, for example, an entry corresponding to a group (e.g. department) to which the administrator belongs, or an entry corresponding to a lower-layer group which is subordinate to this group. The group information generator 201 stores the generated group information 205, for example, in a storage device provided in the management server 2.

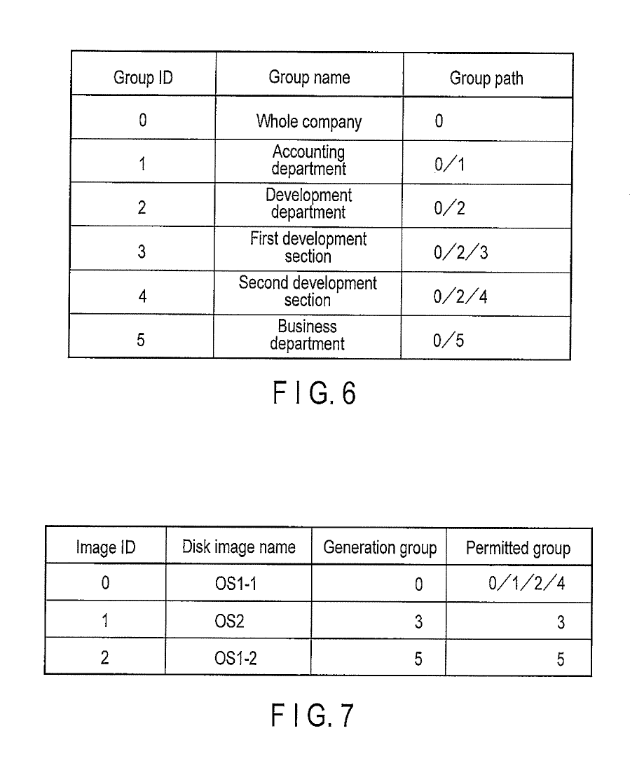

FIG. 6 illustrates a configuration example of the group information 205. The group information 205 includes a plurality of entries corresponding to a plurality of groups. Each entry includes a group ID, a group name, and a group path. In an entry corresponding to a certain group, “Group ID” is indicative of identification information which is given to the group. “Group name” is indicative of the name of the group. “Group path” is indicative of group IDs corresponding to a path starting from an uppermost-layer group to a lower-layer target group, among groups having a hierarchical structure. The group path is described such that group IDs are divided by a predetermined symbol (e.g. slash mark “/”).

The disk image generator 202 generates a disk image file 4 including an operating system (OS) and an application program for a certain group. The disk image generator 202 generates, for example, a first disk image file 4, in which a designated first OS and first application program are installed, for a first group to which an authenticated administrator belongs. Specifically, as regards the generated disk image 4, it is designated for which of the groups the disk image 4 is generated. The first disk image file 4 is, for example, a virtual image file for executing the OS 307 and application program 308 on the virtual machine 304 in the client terminal 31. In the meantime, the disk image file 4 may include other files, in addition to the OS and application program. The disk image generator 202 stores the generated disk image file 4, for example, in the storage device provided in the management server 2.

The disk image generator 202 generates the disk image file 4, for example, by making use of a virtual machine in the management server 2, or a virtual machine in some other server. The virtual machine is realized, for example, by using Hyper-V or VMware®. In addition, the disk image generator 202 may generate the disk image file 4 by making use of a client terminal in which the OS and application program are actually installed.

The disk image information generator 203 generates disk image information 206 corresponding to the generated disk image file 4. The disk image information generator 203 generates, for example, an entry for the generated first disk image 4, in which the first group, to which the authenticated administrator belongs, is set to be a generation group and a permitted group. The disk image information generator 203 then adds this entry to the disk image information 206. The generation group is, for example, the first group to which the administrator, who has requested the generation of the disk image 4, belongs. The permitted group is a group to which the delivery of the disk image file 4 is permitted (i.e. the group which can use the disk image 4). The generation group can alter the content of the disk image 4, and can also set another group as a permitted group. The permitted group can only use the disk image 4, and cannot alter the content of the disk image 4. In the meantime, the permitted group can further set another group to which the delivery of the disk image 4 is permitted. The disk image information 206 is stored, for example, in the storage device provided in the management server 2.

The disk image information generator 203, as described above, can further set a group, which is subordinate to the set permitted group (e.g. a group immediately under the set permitted group), to be the permitted group. Specifically, the disk image information generator 203 can alter the entry of the generated disk image information 206 to add a group that is to be set as the permitted group. For example, the disk image information generator 203 sets a second group, which is subordinate to the first group, to be the permitted group.

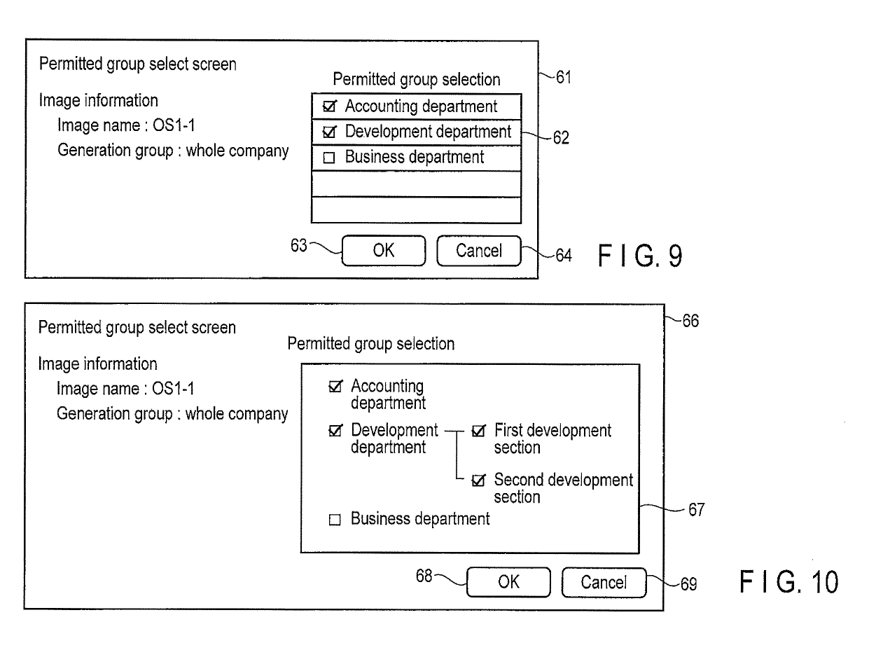

The disk image information generator 203 displays, for example, a permitted group select screen for selecting a permitted group for the generated disk image 4, thereby prompting the administrator to select the permitted group. Then, responding to an input using the permitted group select screen, the disk image information generator 203 alters (adds, changes or deletes) the permitted group included in the entry of the disk image information 206. The permitted group select screen will be described later with reference to FIGS. 9 and 10.

FIG. 7 illustrates a configuration example of the disk image information 206. The disk image information 206 includes a plurality of entries corresponding to a plurality of disk images. Each entry includes, for example, an image ID, a disk image name, a generation group and a permitted group. In an entry corresponding to a certain disk image, “Image ID” is indicative of identification information which is given to this disk image. “Disk image name” is indicative of the name of the disk image. “Generation group” is indicative of the group ID of the group which generated the disk image. “Permitted group” is indicative of the group ID of the group, to which the delivery of the disk image is permitted.

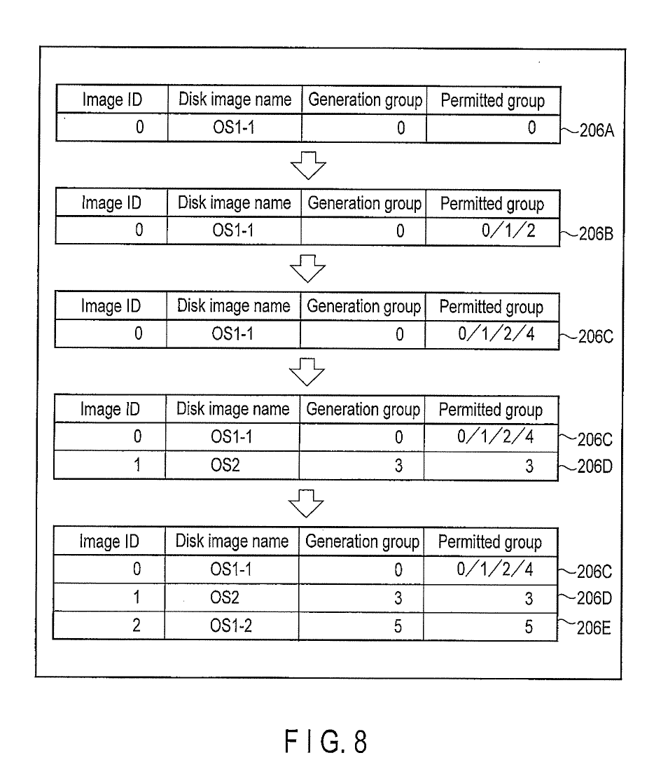

FIG. 8 illustrates an example in which an entry of the disk image information 206 is added according to the generation of the disk image 4 and the setting of the permitted group.

To begin with, it is assumed that the administrator of the “whole company” group 81 has requested the generation of a disk image “OS1-1”. In this case, the disk image generator 202 generates the disk image “OS1-1” including a first OS and a first application, with the “whole company” group 81 (group ID=0) being set as a generation group. Then, the disk image information generator 203 generates an entry 206A of the disk image information 206 (i.e. adds an entry 206A to the disk image information 206). In the entry 206A, “OS1-1” is set in “Disk image name”, and the ID “0” of the “whole company” group 81 is set in “Generation group” and “Permitted group”.

Then, responding to the administrator of the “whole company” group 81 designating a permitted group to which the delivery of the generated disk image “OS1-1” is permitted, the disk image information generator 203 further adds a group ID to the “Permitted group” as shown in an entry 206B. For example, the administrator of the generation group can select whether or not to set a group immediately under the generation group to be a permitted group. In the entry 2068, among the “accounting department” group 82, “development department” group 83 and “business department” group 84 which are immediately under the “whole company” group 81, a group ID “1” of the “accounting department” group 82 and a group ID “2” of the “development department” group 83 are further set in the “Permitted group”. Specifically, in the entry 206B, it is specified that the disk image “OS1-1” can be delivered to the “whole company” group 81, “accounting department” group 82 and “development department” group 83, and that the disk image “OS1-1” cannot be delivered to the “business department” group 84.

In addition, although an administrator of the permitted group cannot alter the disk image “OS1-1”, the administrator of the permitted group can select whether or not to set a group immediately under the group, to which the administrator of this permitted group belongs, to be a permitted group. Specifically, according to the selection by the administrator of the permitted group, the disk image information generator 203 can add a group ID to the “Permitted group”, as shown in an entry 206C. In the entry 206C, of the “first development section” group 85 and “second development section” group 86 immediately under the “development department” group 83, a group ID “4” of the “second development section” group 86 is further set in the “Permitted group”. Specifically, in the entry 206C, it is specified that the disk image “OS1-1” can be delivered to the “second development section” group 86, and cannot be delivered to the “first development section” group 85.

Next, it is assumed that an administrator of the “first development section” group 85 has requested the generation of a disk image “OS2”. In this case, the disk image generator 202 generates the disk image “OS2” including a second OS and a second application program, with the “first development section” group 85 (group ID=3) being set as a generation group. Then, the disk image information generator 203 generates an entry 206D corresponding to the disk image “OS2” (i.e. adds an entry 206D to the disk image information 206). In the entry 206D, “OS2” is set in the “Disk image name”, and the ID “3” of the “first development section” group 85 is set in the “Generation group” and “Permitted group”. Incidentally, since the “first development section” group 85 has no subordinate lower-layer group, no selection of a permitted group is executed.

Similarly, when an administrator of the “business department” group 84 has requested the generation of a disk image “OS1-2”, the disk image generator 202 generates the disk image “OS1-2” including the first OS and a third application program, with the “business department” group 84 (group ID=5) being set as a generation group. Then, the disk image information generator 203 generates an entry 206E corresponding to the disk image “OS1-2” (i.e. adds an entry 206E to the disk image information 206). In the entry 206E, “OS1-2” is set in the “Disk image name”, and the ID “5” of the “business department” group 84 is set in the “Generation group” and “Permitted group”. Incidentally, since the “business development” group 84 has no subordinate lower-layer group, no selection of a permitted group is executed.

In this manner, the entries of the disk image information 206 can be generated and altered in accordance with the generation of the disk image 4 and the setting of the permitted group. By using the disk image information 206 indicative of the association between the disk image 4 and permitted group, it can easily be specified that, for example, when two “child” groups are subordinate to a “parent” group, a disk image for the “parent” group is delivered to one of the two “child” groups, and another disk image is delivered to the other “child” group. In short, the allocation of the disk image 4 to groups can be executed more flexibly. In addition, for example, when the content of the disk image “OS1-1” has been altered by the “whole company” group 81 that is the generation group of the disk image “OS1-1”, the “accounting department” group 82, “development department” group 83 and “second development section” group 86 also use the altered disk image “OS1-1”. Therefore, a plurality of groups, in which the same disk image 4 is used, can efficiently be centrally managed.

Besides, the disk image information generator 203 may vary the range of groups which can be designated as permitted groups, in accordance with operational environments. For example, the disk image information generator 203 may determine a group that is set as the permitted group, not only from among groups which are subordinate to the permitted group, but also from among all the groups. By designating, from among all groups, a group that is set as the permitted group, such setting can easily be executed that a common disk image 4 is used across departments. In this case, for example, in the group tree shown in FIG. 3, such setting can be executed that the disk image 4 for the “accounting department” group 82 is also used in the “business department” group 84. In addition, for example, the disk image information generator 203 may determine a group that is set to be a permitted group, from among groups which are recursively obtained from a group immediately under the permitted group. By designating a group that is set to be a permitted group, from among the recursively obtained groups, the disk image 4 can be set based on the hierarchical superior/subordinate relationship between groups. In this case, for example, in the group tree shown in FIG. 3, as regards the disk image 4 for the “development department” group 83, a permitted group can be selected from among the “whole company” group 81, “development department” group 83, “first development section” group 85 and “second development section” group 86.

The disk image information generator 203 can also alter (add, change or delete) the generation group which is included in the entry of the disk image information 206. This is advantageous, for example, in the case where the management of the disk image 4 is be entrusted to another group, since the group that can alter the content of the disk image 4 is only the generation group, as described above. Incidentally, the number of generation groups for one disk image 4 may be singular or plural.

The delivery controller 204 controls the delivery of the disk image 4 to the client terminal 3 by using the group information 205 and disk image information 206. For example, when the first disk image file 4 for the first group is to be delivered, the delivery controller 204 delivers the first disk image file 4 to the client terminal 3 belonging to the first group, and to the client terminal 3 belonging to the permitted group to which the delivery of the first disk image file 4 is permitted.

To be more specific, when the first disk image file 4 for the first group is to be delivered, the delivery controller 204 reads the entry of the disk image information 206, which corresponds to the first disk image 4. Using the group information 205, the delivery controller 204 detects the group corresponding to the group ID which is indicated in the “Permitted group” of the entry. The delivery controller 204 delivers the first disk image file 4 to the client terminals 3 belonging to the detected groups (the permitted groups including the generation group).

In the meantime, the delivery controller 204 may deliver the disk image 4 in response to a request by the client terminal 31. Specifically, for example, when the delivery of the disk image 4 has been requested by the client terminal 31, the delivery controller 204 detects the group, to which the client terminal 31 belongs, by using the group information 205. Using the disk image information 206, the delivery controller 204 detects the disk image 4 which is permitted to be delivered to the detected group.

The delivery controller 204 then transmits the detected disk image 4 to the client terminal 31. In the meantime, when a plurality of disk images 4, the delivery of which has been permitted, are detected, the delivery controller 204 may select one of the disk images 4 and may transmit the selected disk image 4.

In addition, the timing at which the disk image 4 is delivered by the delivery controller 204 may be, for instance, when the disk image 4 has newly been generated, when the disk image 4 has been updated, or when the permitted group, to which the delivery of the disk image is permitted, has been altered.

FIGS. 9 and 10 show examples of the permitted group select screen which is displayed by the disk image information generator 203. In the examples shown in FIGS. 9 and 10, it is assumed that the administrator of the generation group (in this example, the administrator of the “whole company” group 81) selects a permitted group which is set for the generated disk image “OS1-1”.

A permitted group select screen 61 shown in FIG. 9 includes a permitted group select area 62, an OK button 63 and a cancel button 64. In the permitted group select area 62, for example, check buttons indicative of groups immediately under the generation group are disposed. The administrator of the generation group sets the buttons, which correspond to groups that are to be set as permitted groups, in a checked state, and then presses the OK button 63. Responding to this operation, the disk image information generator 203 sets the groups corresponding to the buttons set in the checked state (in FIG. 9, “accounting department” group 82 and “development department” group 83) to be the permitted groups in the entry of the disk image information 206, which corresponds to the target disk image 4.

A permitted group select screen 66 shown in FIG. 10 includes a permitted group select area 67, an OK button 68 and a cancel button 69. In the permitted group select area 67, check buttons corresponding to lower-layer groups which are subordinate to the generation group are disposed in a tree structure. The administrator of the generation group sets the buttons, which correspond to groups that are to be set as permitted groups, in a checked state, and then presses the OK button 68. Responding to this operation, the disk image information generator 203 sets the groups corresponding to the buttons set in the checked state (in FIG. 10, “accounting department” group 82, “development department” group 83, “first development section” group 85 and “second development section” group 86) to be the permitted groups in the entry of the disk image information 206, which corresponds to the target disk image 4.

Returning to FIG. 5, the management module 305A, which is executed on the client terminal 31, includes a delivery request module 51 and a disk image receiver 52. The delivery request module 51 requests the delivery of the disk image 4 from the management server 2. The delivery request module 51 transmits a delivery request for the disk image 4 to the management server 2, for example, at regular intervals, or when the use of the client terminal 3 by the user has been started, or when a predetermined operation by the user has been executed.

Then, the disk image receiver 52 receives the disk image 4 which has been delivered by the management server 2 (delivery controller 204). The disk image receiver 52 stores the received disk image 4, for example, in the storage device provided in the client terminal 3. Thereby, using the stored disk image 4, the client terminal 3 can execute, on the virtual machine 304, the user's use OS 307 and application program 308 which are installed in the disk image 4.

By the above-described structure, when the client terminals 3 are managed by using the groups which are hierarchically organized, the files, which are delivered to the client terminals 3, can efficiently be managed. The disk image generator 202 generates a disk image file 4 for a certain group, which includes an OS and an application program. The disk image information generator 203 generates disk image information 206 corresponding to the generated disk image file 4. In this disk image information 206, a generation group, which generated the file 4, and a permitted group, to which the delivery (use) of the file 4 is permitted, are associated with the generated disk image file 4. The generation group can alter the file 4 and can add another group as a permitted group. On the other hand, the permitted group can add another group as a permitted group. The delivery controller 204 delivers the disk image file 4 to the client terminal 3 belonging to the permitted group. Thereby, the content of the disk image file 4 can be managed based on the generation group, and the groups, to which the disk image file 4 is allocated, can be managed based on the permitted group. Specifically, by setting the generation group and the permitted group, the content of the disk image file 4 and the delivery of the disk image file 4 can separately be managed.

In the meantime, the above-described disk image information 206 may be specified such that a plurality of disk images can be delivered to one group.

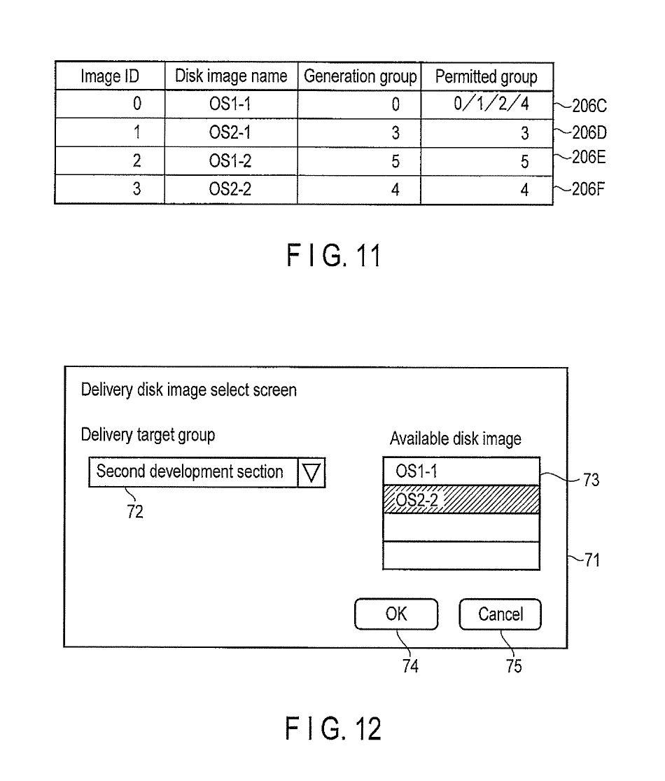

FIG. 11 illustrates an example of the disk image information 206 which indicates that a plurality of disk images can be delivered to one group. Specifically, a group (“second development section” group 86) of a group ID “4” is set in each of an entry 206C corresponding to a disk image “OS1-1” and an entry 206F corresponding to a disk image “OS2-2”. In addition, from the entry 206F, it is understood that the generation group of the disk image “OS2-2” is the group (“second development section” group 86) of the group ID “4”. In this case, the administrator selects which of the disk images 4 is to be delivered to the group. FIG. 12 illustrates an example of a delivery disk image select screen which is displayed by the delivery controller 204, when a plurality of disk images can be delivered to one group. A delivery disk image select screen 71 includes a group select button 72, a disk image select area 73, an OK button 74 and a cancel button 75. The group select button 72 is a button for selecting a group that is a target of delivery. In the disk image select area 73, buttons indicative of disk images 4, which can be delivered to the delivery target group, are disposed. The administrator selects a button corresponding to a disk image 4 which is to be delivered to the target group, and then presses the OK button 74. Responding to this operation, the delivery controller 204 determines the disk image 4 which is to be delivered to the target group.

In the example shown in FIG. 12, the “second development section” group 86 is selected as the delivery target group by using the group select button 72. In this case, in the disk image select area 73, buttons indicative of disk images “OS1-1” and “OS2-2”, which can be delivered, are disposed based on the disk image information 206 shown in FIG. 11. Accordingly, for example, by the administrator selecting the button indicative of “OS2-2”, the “OS2-2” is delivered to the client terminal 3 belonging to the “second development section” group 86.

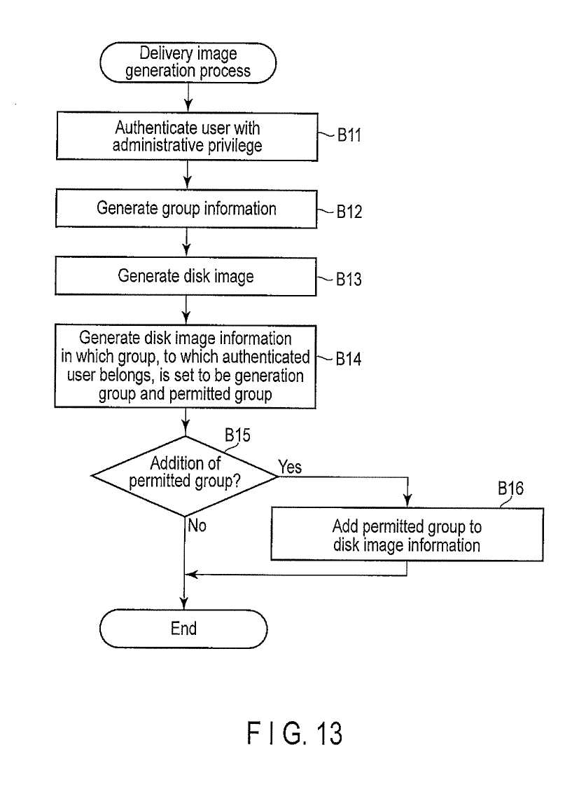

Next, referring to a flowchart of FIG. 13, a description is given of an example of the procedure of a delivery image generation process which is executed by the management server 2.

To start with, the group information generator 201 authenticates a user (administrator) having an administrative privilege (block B11). Specifically, the group information generator 201 determines whether the user, who accesses the management server 2, has the administrative privilege, and permits the access to the management server 2 by the user with the administrative privilege and prohibits the access to the management server 2 by the user without the administrative privilege. Thus, in accordance with the operation by the user with the administrative privilege, the subsequent process is executed.

Subsequently, the group information generator 201 generates the group information 205 (block B12). For example, in accordance with an input by the administrator, the group information generator 201 adds to the group information 205 an entry corresponding to a group to which the administrator belongs, or an entry corresponding to a lower-layer group which is subordinate to this group.

Then, the disk image generator 202 generates a disk image 4 for a group indicated in the generated group information 205 (block B13). This disk image 4 is, for example, a virtual disk image in which an operating system (OS) and an application program are installed.

The disk image information generator 203 generates disk image information 206 in which the group, to which the authenticated user (administrator) belongs, is set to be a generation group and a permitted group, in association with the generated disk image 4 (block B14). Then, the disk image information generator 203 determines whether a permitted group is added in association with the generated disk image 4 (block B15). When a permitted group is added (YES in block B15), the disk image information generator 203 sets the added permitted group in the entry of the disk image information 206, which corresponds to the disk image 4 (block B16). The added permitted group is, for example, a group which is subordinate to the group that has already been set as the permitted group.

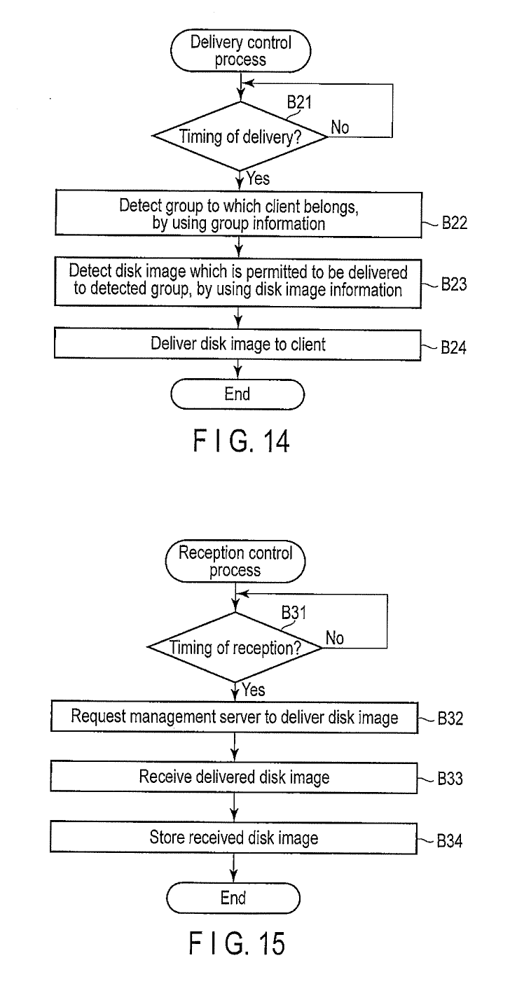

FIG. 14 is a flowchart illustrating an example of the procedure of a delivery control process which is executed by the management server 2.

To start with, the delivery controller 204 determines whether a timing at which the disk image 4 is delivered has come (block B21). Specifically, the delivery controller 204 determines whether, for example, a delivery request for the disk image 4, which has been transmitted from the client terminal 3, has been received or not. When the delivery timing has not come (NO in block B21), the process returns to block B21, and it is determined once again whether a timing to deliver the disk image 4 has come.

On the other hand, when the delivery timing has come (YES in block B21), the delivery controller 204 detects the group to which the target client terminal 3 belongs, by using the group information 205 (block B22). Using the disk image information 206, the delivery controller 204 detects the disk image 4 which is permitted to be delivered to the detected group (block B23). Then, the delivery controller 204 delivers the detected disk image 4 to the client terminal 3 (block B24). In the meantime, when a plurality of disk images 4 are detected, the delivery controller 204 may selectively deliver one of the disk images 4.

Next, referring to a flowchart of FIG. 15, a description is given of an example of the procedure of a reception control process which is executed by the client terminal 3.

To start with, the delivery request module 51 determines whether a timing to receive the disk image 4 from the management server 2 has come or not (block B31). The delivery request module 51 determines that the timing to receive the disk image 4 has come, for example, at regular intervals, or when the use of the client terminal 3 by the user is started. When the timing to receive the disk image 4 has not come (NO in block B31), the process returns to block B31, and it is determined once again whether the timing to receive the disk image 4 has come or not.

When the timing to receive the disk image 4 has come (YES in block B31), the delivery request module 51 requests the delivery of the disk image 4 from the management server 2 (block B32). Then, the disk image receiver 52 receives the disk image 4 which has been delivered from the management server 2 (block B33). The disk image receiver 52 stores the received disk image 4, for example, in the storage device provided in the client terminal 3 (block 834). Thereby, using the stored disk image 4, the user's use OS 307 and application program 308, which are installed in the disk image 4, can be executed on the virtual machine 304.

As has been described above, according to the present embodiment, when client terminals 3 are managed by hierarchically organized groups, the files that are delivered to the client terminals 3 can efficiently be managed. In this embodiment, the content of the disk image file 4 can be managed based on the generation group which generated the disk image file 4, and the groups, to which the disk image file 4 is delivered, can be managed based on the permitted group which is permitted to use the file 4.

All the process procedures of this embodiment, which have been described with reference to the flowcharts of FIGS. 13 to 15, can be executed by software. Thus, the same advantageous effects as with the present embodiment can easily be obtained simply by installing a computer program, which executes the process procedures, into an ordinary computer through a computer-readable storage medium which stores the computer program, and by executing the computer program.

The various modules of the systems described herein can be implemented as software applications, hardware and/or software modules, ox components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus configured to manage a plurality of client terminals belonging to groups organized hierarchically, the apparatus comprising:
an image file generator configured to generate a first disk image file for a first group of the groups, the first disk image file comprising a first operating system and a first application program;
a permitted group setting module configured to set a second group of the groups to be a permitted group to which delivery of the first disk image file is permitted, wherein the second group is subordinate to the first group; and
a delivery controller configured to deliver the first disk image file to a client terminal belonging to the first group and a client terminal belonging to the permitted group.

2. The information processing apparatus of claim 1, wherein the image file generator is configured to further generate a second disk image file for a third group of the groups, wherein the third group is subordinate to the second group, and the second disk image file comprises a second operating system and a second application program, and
wherein the delivery controller is configured to further deliver the second disk image file to a client terminal belonging to the third group.

3. The information processing apparatus of claim 2, wherein the permitted group setting module is configured to further set a fourth group of the groups to be the permitted group, and wherein the fourth group is subordinate to the second group.

4. The information processing apparatus of claim 1, wherein the image file generator is configured to further generate a second disk image file for a third group of the groups, wherein the third group is subordinate to the first group, and the second disk image file comprises a second operating system and a second application program, and
wherein the delivery controller is configured to further deliver the second disk image file to a client terminal belonging to the third group.

5. The information processing apparatus of claim 4, wherein the permitted group setting module is configured to further set a fourth group of the groups to be the permitted group, and wherein the fourth group is subordinate to the second group.

6. The information processing apparatus of claim 1, wherein the permitted group setting module is configured to further set a third group of the groups to be the permitted group, and wherein the third group is subordinate to the second group.

7. The information processing apparatus of claim 1, wherein the image file generator is configured to generate the first disk image file in accordance with an operation by an administrator of the first group, and
the permitted group setting module is configured to set the second group to be the permitted group in accordance an operation by the administrator of the first group.

8. The information processing apparatus of claim 7, wherein the permitted group setting module is configured to further set a third group of the groups to be the permitted group in accordance an operation by an administrator of the second group, wherein the third group is subordinate to the second group.

9. A client management method of managing a plurality of client terminals belonging to groups organized hierarchically, the method comprising:
generating a first disk image file for a first group of the groups, the first disk image file comprising a first operating system and a first application program;
setting a second group of the groups to be a permitted group to which delivery of the first disk image file is permitted, wherein the second group is subordinate to the first group; and
delivering the first disk image file to a client terminal belonging to the first group and a client terminal belonging to the permitted group.

10. The client management method of claim 9, wherein generating the image file comprises generating a second disk image file for a third group of the groups, the third group is subordinate to the second group, and the second disk image file comprises a second operating system and a second application program, and
wherein the delivering further comprises delivering the second disk image file to a client terminal belonging to the third group.

11. The client management method of claim 10, wherein setting the permitted group further comprises setting a fourth group of the groups to be the permitted group, and wherein the fourth group is subordinate to the second group.

12. The client management method of claim 9, wherein setting the permitted group further comprises setting a third group of the groups to be the permitted group, wherein the third group is subordinate to the second group.

13. A computer-readable, non-transitory storage medium having stored thereon a program which is executable by a computer and causes the computer to manage a plurality of client terminals belonging to groups organized hierarchically, the program controlling the computer to execute functions of:
generating a first disk image file for a first group of the groups, the first disk image file comprising a first operating system and a first application program;
setting a second group of the groups to be a permitted group to which delivery of the first disk image file is permitted, wherein the second group is subordinate to the first group; and
delivering the first disk image file to a client terminal belonging to the first group and a client terminal belonging to the permitted group.

14. The storage medium of claim 13, wherein generating the image file further comprises generating a second disk image file for a third group of the groups, wherein the third group is subordinate to the second group, and the second disk image file comprises a second operating system and a second application program, and
wherein the delivering further comprises delivering the second disk image file to a client terminal belonging to the third group.

15. The storage medium of claim 14, wherein setting the permitted group further comprises setting a fourth group of the groups to be the permitted group, and wherein the fourth group is subordinate to the second group.

16. The storage medium of claim 13, wherein setting the permitted group further comprises setting a third group of the groups to be the permitted group, and wherein the third group is subordinate to the second group.
